(19) United States
(12) Patent Application Publication
(10) Pub. No.: US 2005/0188573 A1
(43) Pub. Date: Sep. 1, 2005

(54) Portable display for personal information

(76) Inventor: Michael Vincent Taylor, Rowville (AU)

Correspondence Address: Henneman & Saunders, 714 W. Michigan Ave., Three Rivers, MI, 49093, US

(21) Appl. No.: 11/067,026

(22) Filed: Feb. 25, 2005

(30) Foreign Application Priority Data
Feb. 27, 2004 (AU) 2004900990

(51) Int. Cl. G09F 7/02

(52) U.S. Cl. 40/618

(57) ABSTRACT

The invention is a portable display such a name badge for presenting removable inserts which carry indicia such as letters providing personal information related to the bearer of the display. The display includes a base panel having a front and a rear and a face panel overlying the base panel and having at least one window through which the indicia are visible. A recess between the base panel and the face panel receives and locates therein the plurality of removable inserts carrying the indicia. The rear of the base panel has an access aperture such as a slot in communication with the recess through which the inserts can be selectively inserted and removed. Each insert is made of a flexible and resilient material, the flexibility allowing deformation of the insert upon insertion through the access aperture into the one recess and upon removal of the insert, the resilience enabling the insert to return at least partially to its original shape upon being fully inserted through the access aperture into its desired final position in the recess.

### RELATED APPLICATIONS

This application claims the right of foreign priority under 35 U.S.C. §119 to Application Serial Number 2004900990 filed in Austrailia on Feb. 27, 2004 by the same inventor, which is incorporated herein by reference in its entirety.

1. Field of Invention

This invention relates to portable information displays, such as reusable name badges.

2. Background

Name tags or badges are commonly used to identify the name of the wearer. They may be issued to people attending conventions, meetings, parties and are often worn by employees of a company to identify both the name of the company and the employee. These name tags or badges commonly consist of a flat display area affixed to a clip or clasp which can be temporarily fastened to clothing. Such name tags or badges may range from an adhesively backed paper name tag to a high quality personalised engraved or etched badge.

It is difficult to make high quality name tags or badges which are reusable. Often high quality name tags are made for an individual by engraving, etching or printing the name of the individual on the name tag. Badges are known in which there is a channel into which a name strip can be removably placed, however, such a name strip still requires manufacture individually by printing or typing.

It is an object of the present invention to overcome or ameliorate at least one of the aforementioned disadvantages of the prior art or at least provide a useful alternative thereto.

### SUMMARY OF INVENTION

According to a first aspect of the present invention there is provided a portable display for visibly displaying personal information related to the bearer of the display, the portable display including:
a base panel having a front and a rear;
a face panel overlying the base panel and having at least one window through which indicia providing the personal information are visible;
at least one recess which is between the base panel and the face panel and which is shaped to receive and locate a plurality of removable inserts carrying said indicia;
the rear of the base panel having an access aperture in communication with said at least one recess through which said plurality of inserts can be selectively inserted and removed.

According to a second aspect of the present invention there is provided, in combination, a portable display and a plurality of removable inserts which carry indicia providing personal information related to the bearer of the display, the portable display including:
a base panel having a front and a rear;
a face panel overlying the base panel and having at least one window through which the indicia providing the personal information are visible;
at least one recess which is between the base panel and the face panel and which receives and locates therein the plurality of removable inserts carrying said indicia;
the rear of the base panel having an access aperture in communication with said at least one recess through which said plurality of inserts can be selectively inserted and removed, each insert being made of a flexible and resilient material, the flexibility allowing deformation of the insert upon insertion through the access aperture into said at least one recess and upon removal of the insert from said at least one recess through the access aperture, the resilience enabling the insert to tend to return at least partially to its original shape upon being fully inserted through the access aperture into its desired final position in said at least one recess.

The portable information displays of the present invention are for providing personal information such as name, position or status of the bearer, security classification of the bearer. In a preferred embodiment the information display is a name tag or badge. Hereinafter the invention will be primarily described with reference to name badges but it is to be understood that the invention has a wider application.

Badges of the present invention can be made having a high quality finish. Pre-printed inserts carrying indicia, usually letters, can be individually inserted to form a name which is visible through at least one window. No equipment such as a typewriter or printer is required to manufacture a name strip as the inserts can be preprinted with individual letters.

The badges of the present invention overcome a problem associated with turnover of staff in companies where employees leave and new name tags must be manufactured for new employees. When an employee leaves the company the name tags according to the present invention may be reused by removing the old inserts and inserting fresh ones. Also, for events such as conferences where high quality name badges are required, portable displays in the form of badges of the invention provide an alternative to commonly used conference name badges.

The face panel preferably bears an attractive surface finish and may be provided with information or other markings common to a series of badges, such as a company name, logo, job title of a person, etc. The information common to the series of badges may be provided by any suitable means such as printing, etching or engraving the face panel. The face panel has at least one window through which indicia such as letters placed together to form a name are visible.

The face panel is constructed from any suitable material such as printed or engraved foil or plastic, for example a coated acrylic. It is preferred that the face panel is made of a material having a pleasing decorative finish and is preferably opaque. In all embodiments of the invention, there may be a protective and aesthetically pleasing clear coating or layer over the front of the face panel, such as a clear UV curable glaze applied to the face panel covering the front including the window(s).

In the preferred embodiments the access aperture has a closed perimeter boundary entirely within the periphery of the rear of the base panel. For example, the access aperture may comprise an elongated slot in the rear of the base panel through which the inserts can be inserted and removed at different positions along the length of the elongated slot.

Preferably, the access aperture in the rear of the base panel in cross-section is offset from the recess so that the inserts are required to bend upon being inserted and removed through the access aperture. In this preferred construction, each insert is preferably made of a flexible and resilient material, the flexibility allowing deformation of the insert upon insertion through the access aperture into said at least one recess and upon removal of the insert from said at least one recess through the access aperture, the resilience enabling the insert to tend to return at least partially, and preferably to return substantially completely, to its original shape upon being fully inserted through the access aperture into its desired final position in said at least one recess. This can help provide a positive “feel” when a user is inserting the inserts as the inserts resiliently spring or snap back to their original shape upon complete insertion to their desired final positions.

In the preferred portable display, the or each recess is a generally planar recess and the access aperture provides no access to the recess in the plane thereof, i.e. through an edge of the planar recess. This arrangement ensures the inserts are required to bend upon being inserted through the access aperture into the planar recess and are required to bend upon being removed from the planar recess out through the access aperture. The inserts are thus prevented or inhibited from falling out of the recess accidentally upon shocks or vibration.

The preferred portable display further includes a translucent layer between the face panel and the base panel and which overlies the inserts when located in the recess and which provides visibility for the indicia through the window and through the translucent layer.

In one possible embodiment the translucent layer comprises a translucent protective panel interposed between the face panel and the base panel such as a transparent layer interposed between the base panel and the face panel, instead of the interposed layer, the protective panel may have a raised portion on the rear face of the protective panel, the raised portion being of complementary shape to recess but being of lesser thickness than the recess whereby both the raised portion of the protective panel and the inserts can be received within the recess.

In an alternative possible embodiment, the translucent layer comprises part of the face panel. In this embodiment, the face panel is preferably composed of a transparent material and the window of the face panel is defined by opaque or less transparent areas of the face panel where decorative or information matter is displayed.

The protective layer (whether a separate interposed component or part of the face panel) can be made of any suitable material such as acrylic, polycarbonate, nylon, PET or other plastics material.

The base panel has a front and a rear. The base panel may be made of any suitable material such as acrylic, polycarbonate, nylon, PET or other plastics material, composite material or metal. There may be a single recess to accommodate multiple inserts, or multiple recesses with each recess being shaped to accommodate one respective insert. The recess or recesses may be formed by any suitable means such as moulding or by cutting (such as laser cutting) the recess shapes in plastics sheets.

Preferably, the or each recess is shaped so that each insert is positively located and retained in its desired position therein to resist accidental displacement. For example, each recess may have a profiled part of its periphery to receive and locate a complementary shaped portion of the periphery of an insert to be received and located therein. The part of the periphery may comprise a concave bay in the respective recess remote from the access aperture so as to receive and positively locate the respective insert at its periphery furtherest from the access aperture. Alternatively, or in addition, the profiled part of the periphery may comprise a concave bay adjacent to the access aperture so as to thereby receive and locate a shaped part of the insert proximate to the access aperture, the shaped part of the insert received within the concave bay proximate to the access aperture being accessible through the access aperture to enable removal of the insert back out through the access aperture. In this arrangement the access aperture may be provided with a number of concave formations along an edge thereof aligned with and of similar shape to the concave bays in the recesses proximate to the access aperture, the concavities in the access aperture being operative to receive and assist location of respective inserts being inserted through the access aperture into the recesses and to enable access to the respective profiled parts of the peripheries of the inserts for removal of the inserts from the recesses through the access aperture.

When the face panel overlies the base panel, the recess or recesses is/are preferably shaped such that the inserts are securely held and aligned so that they do not move in use. In one embodiment, there is a single elongated recess having a number of profiled sections in its periphery along its length, the profiled sections being located and operative to receive complementary shaped parts of the inserts whereby the inserts when located in position are all securely held against accidental movement during use of the portable display.

It is preferred that the inserts are made of a material that is visually unobtrusive so that the inserts are not readily perceived as separate pieces. In the preferred embodiment each insert is made of transparent plastics material, e.g. sheet PET, having the indicia applied thereto in a contrasting colour to a background visible through the window beyond the inserts. The indicia, e.g. letters, are preferably printed in a contrasting colour to the background.

If desired, a strip of material can be placed in the recess prior to assembly of the badge in order to provide a desired background colour to the indicia such as the bearer's name.

In the preferred embodiments each insert is provided with a small hole which remains visible and accessible through the access aperture when the insert is located in its desired position, the small hole being engageable for drawing the insert back out through the access aperture. A pin or other tool may be inserted through the aperture into the small hole enabling the insert to be grasped and removed through the aperture.

### BRIEF DESCRIPTION OF THE DRAWINGS

Possible and preferred features of the present invention will now be described with particular reference to the accompanying drawings. However, it is to be understood that the features illustrated in and described with reference to other drawings are not to be construed as limiting on the scope of the invention. In the drawings:

FIG. 1 is a plan view of the assembled badge according to an embodiment of the invention;

FIG. 1a is an exploded view in perspective of the components of a badge according to a first embodiment of the invention;

FIG. 1b is a perspective view of the rear of the base panel;

FIG. 2 is a plan view of a front panel;

FIG. 3 is a plan view of the clear protective layer;

FIG. 4 is a plan view of the front of the base panel;

FIG. 5 is a plan view of the rear of the base panel;

FIG. 6 is a plan view of an insert;

FIG. 7 is a cross sectional view along line A-A of FIG. 1;

FIG. 8 is a cross sectional view along line B-B of FIG. 1;

FIG. 9 is an exploded view in perspective of the components of a badge according to a second embodiment of the invention;

FIG. 9a is a perspective view of the rear of the base panel;

FIG. 10 is a plan view of a front panel according to a second embodiment of the invention;

FIG. 11 is a plan view of the clear protective layer according to a second embodiment of the invention;

FIG. 12 is a plan view of the front of the base panel according to a second embodiment of the invention;

FIG. 13 is a plan view of the rear of the base panel according to a second embodiment of the invention;

FIG. 14 is a plan view of an insert according to a second embodiment of the invention;

FIG. 15 is an exploded view in perspective of the components of a badge according to a third embodiment of the invention;

FIG. 16 is an exploded view (from the rear side) in perspective of the components of a badge according to a fourth embodiment of the invention.

### DESCRIPTION OF PREFERRED EMBODIMENTS

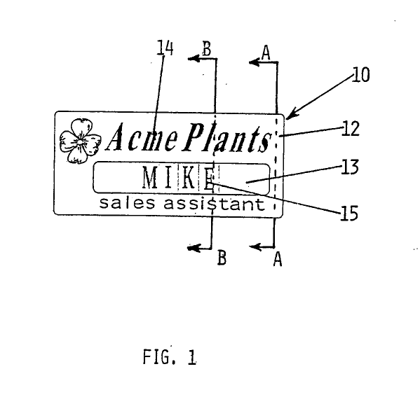

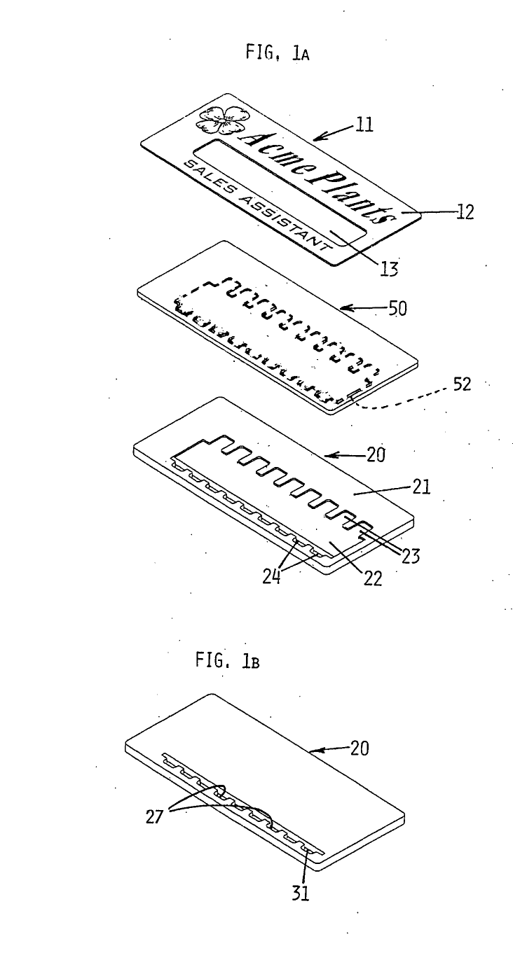

In FIG. 1 there is shown an assembled name badge 10 according to the invention. The badge 10 includes a face panel 12 and window 13. Through the window can be seen inserts bearing indicia such as letters to form a name 15. Face panel 12 carries decoration and/or information 14.

The name badge is made up of a number of layers.

In FIG. 1a there is shown an exploded view of the components of a name badge according to an embodiment of the invention. The badge 10 includes a face panel 11, clear protective layer 50 and base panel 20.

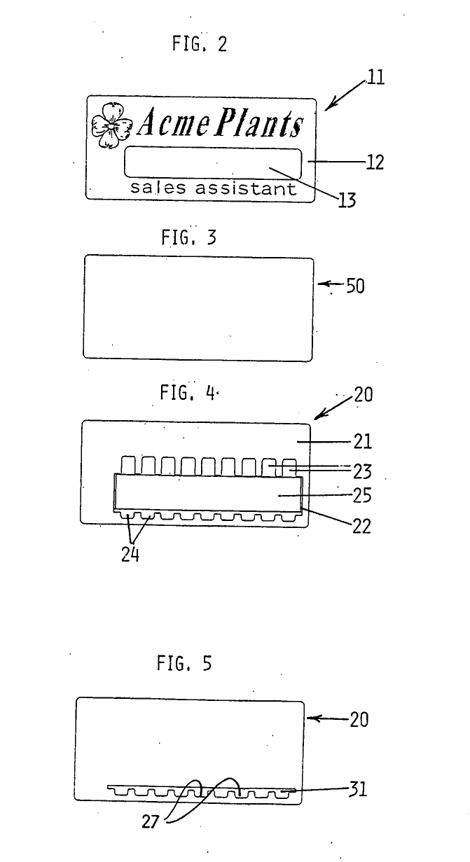

In FIG. 2 is shown face panel 11. Face panel 11 has a front 12 carrying information 14 and has a window 13. The window is positioned so that when the layers are assembled the indicia are visible through the window.

In FIG. 3 is shown protective layer 50. This is made of a clear plastics, e.g. polycarbonate, and protects the indicia from damage. Optionally only, the protective panel 50 has a raised portion 52 on the rear face of the protective panel, the raised portion 52 being of complementary shape to a recess 22 in the base panel 20 but being of lesser thickness than the recess. This enables the raised portion 52 of the protective panel to be received within the recess 22 but leaving sufficient space for the inserts to be received in the recess. The raised portion helps keep accurate registry of the protective panel 50 with the base panel 20.

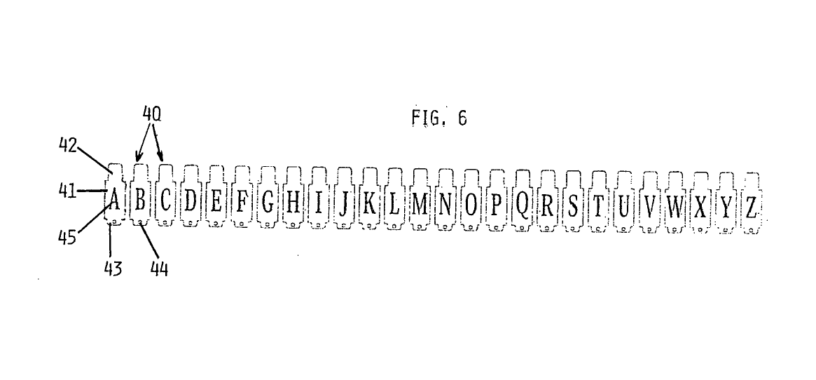

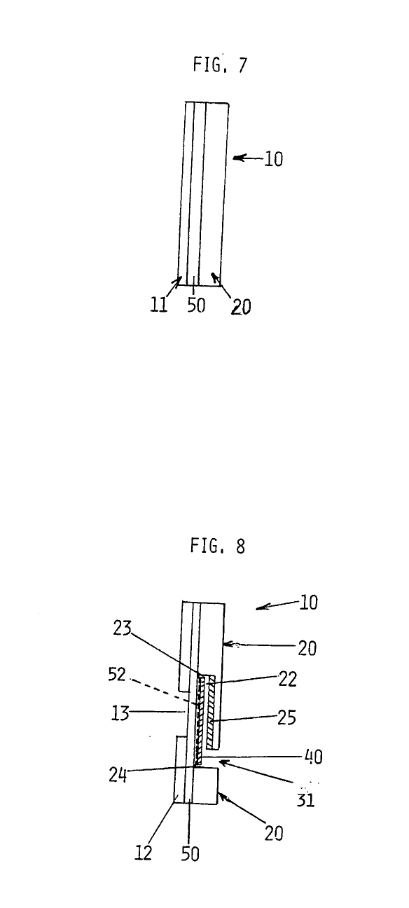

In FIG. 4 there is shown the front of a base panel 20. Base panel 20 is formed from plastics body 21 in which there is provided by moulding, machining, etc. a recess 22. The depth of recess 22 is such that the inserts 40 shown in FIG. 6 fit snugly between the base panel 20 and either face panel 12 or a clear layer 50 shown in FIGS. 7 and 8 when assembled. The recess 22 is also shaped such that the inserts 40 shown in FIG. 6 are retained in fixed positions. In this embodiment the recess 22 has a number of profiled parts of its periphery defining bays 23 and 24 which receive complementary shaped parts, namely tabs 42 and 43, of inserts 40. Bays 24 are proximate to registering concave formations 27 along the edge of the access aperture 31 (FIGS. 1B, 5).

In particular, the access aperture 31 is provided with a number of concave formations 27 along an edge thereof aligned with and of similar shape to the concave bays 24 in the recess(es) 22 proximate to the access aperture, the concavities 27 in the access aperture being operative to receive and assist location of respective inserts 40 being inserted through the access aperture 31 into the recesses and to enable access to the respective profiled parts 43 of the peripheries of the inserts for removal of the inserts from the recesses through the access aperture.

A background layer 25 is placed in the recess 22 prior to assembly in order to provide a desired background colour to the indicia.

In FIG. 5 there is shown the rear of base panel 20. Base panel 20 includes an access aperture or slot 31 having a closed perimeter boundary entirely within the periphery of the rear of the base panel 20. The aperture 31 provides communication with recess 22, not through an edge in the plane of recess 22, but from a direction out of the plane. A plurality of inserts 40, shown in FIG. 6 can be inserted through the access aperture 31 at different positions along its length to lie in recess 22. The inserts 40 are made of flexible and resilient material and they bend upon being inserted through the access aperture 31 which, in cross-section, is offset from the plane of the recess 22 (see FIG. 8). The flexibility of the material of the inserts 40 allows the deformation upon insertion (and removal) and the resilience enables the inserts 40 to return with a positive snap action to their flat original shape when fully inserted and accurately positioned in the recess 22. This arrangement and action inhibits accidental dislodgment or removal of the inserts 40. The rear of base panel 20 is provided with a clip or clasp (not shown) which may be of any known type such as a pin, clip or magnet. Alternatively, the badge may be suspended on a lanyard.

In FIG. 6 there are shown a number of inserts 40. Insert 40 has a body 41 which can be seen through window 13. Body 41 has tabs 42 and 43 which cooperate with respective bays 23 and 24 to locate insert 40 in position. Insert 40 is provided with a small hole 44 which is exposed and accessible through access aperture 31 when insert 40 is in position. A pin or other similar tool may be inserted through the aperture 31 and into hole 44 enabling the insert to be grasped and removed through the aperture 31. Insert 40 carries indicia 45 such as letters visible in use through window 13. A clear polycarbonate protective layer 50 is sandwiched between the base panel 20 and face panel 11.

In FIG. 7 there is shown a side view of the badge of the present invention along line A-A of FIG. 1 with the thickness of the components exaggerated for clarity. The badge 10 consists of face panel 12, clear layer 50 and base panel 20.

In FIG. 8 is shown a cross section along line B-B of FIG. 1 with the thickness of and gaps between components exaggerated for clarity. Badge 10 consists of face panel 12 having window 13. A clear protective layer 50 is sandwiched between face panel 12 and base panel 20. Base panel 20 has recess 22 in which has been secured background layer 25. Insert 40 has been inserted through aperture 31 to lie in recess 22 and is located in position assisted by cooperation with bays 23, 24.

The layers are secured together by any suitable means, such as adhesive. For example, plastics sheets with adhesive layer covered by a removable peel-off cover sheet can be laser cut to form components.

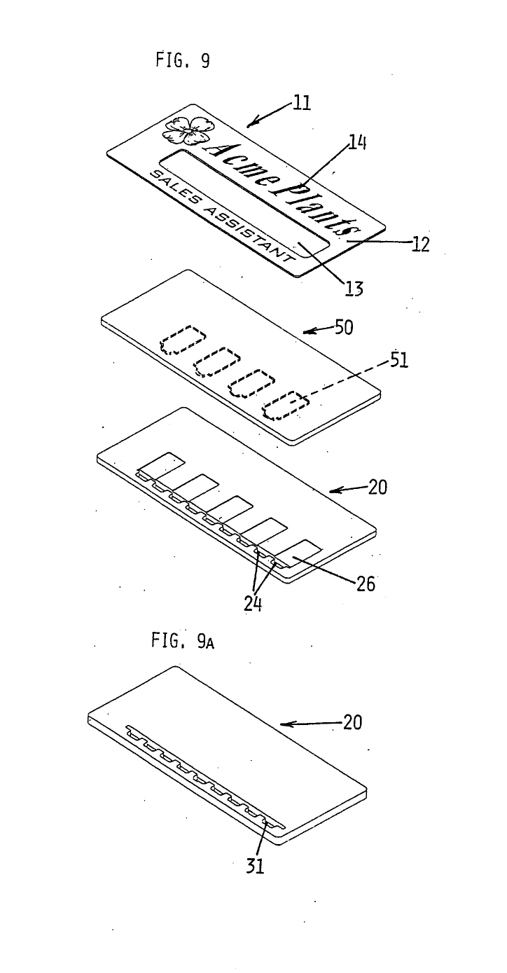

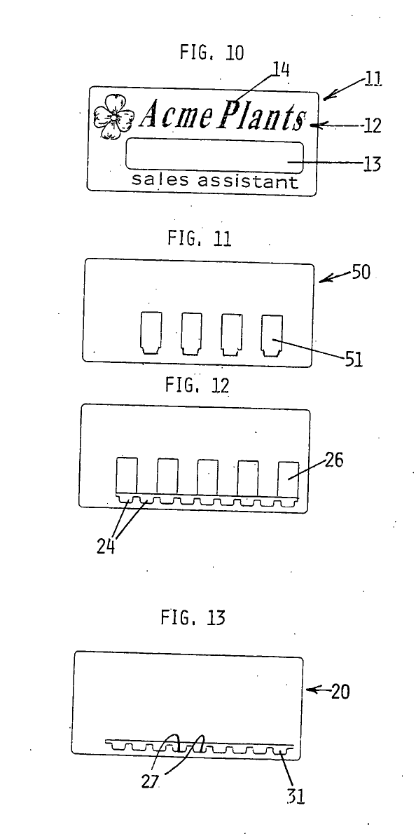

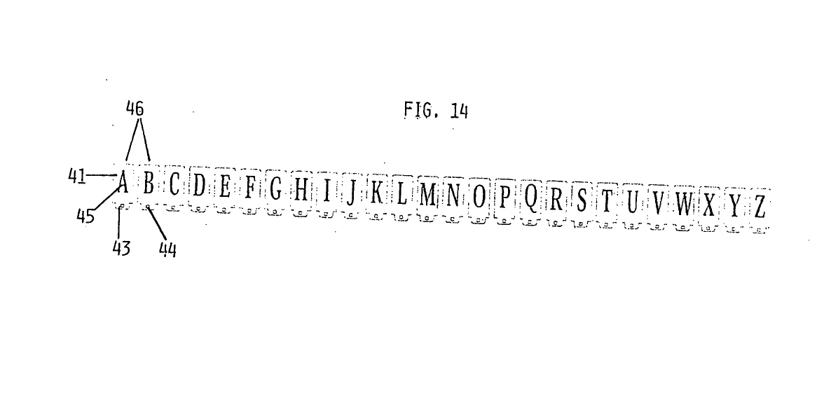

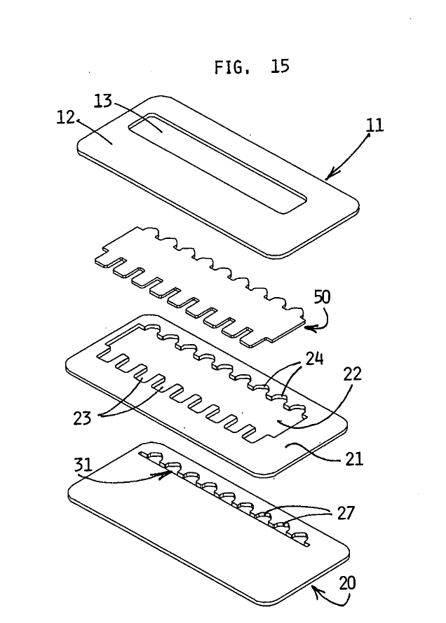

FIG. 9 shows an exploded view in perspective of the individual components of a badge according to a second embodiment of the invention. In this embodiment protective layer 50 is provided in its rear face with a series of recesses 51 which, when the badge 10 is assembled, alternate with a series of recesses 26 which are provided in the front of base panel 20. Each recess 26, 51 accommodates one insert. This embodiment of the invention allows for easy insertion of inserts 46 shown in FIG. 14. It also means that the inserts 46 are unable to move laterally within the recesses 51 and 26 and means that inserts 46 do not need to be provided with tabs 42 to locate inserts 46 in position.

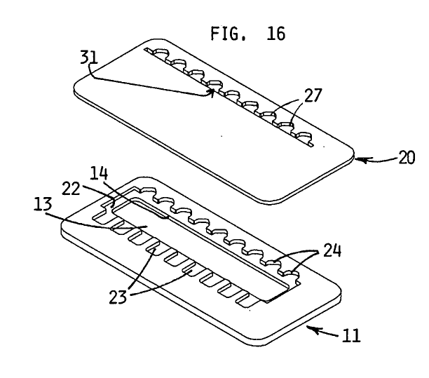

In FIG. 15 the components and assembly are similar to FIG. 1a except that the base panel 20 is made of two parts—the backing panel 20 and the body 21 defining the recess 22 cut therein. These two parts are assembled and secured together to form a base panel similar to FIG. 1a. Another difference relates to the protective translucent layer 50 interposed between the face panel 11 and the base panel 20 which in FIG. 15 does not overlie the base panel 20. The protective panel 50 is of complementary shape to the recess 22 but is of lesser thickness (e.g. 0.5 mm) than the recess (e.g. 0.75 mm) so that the protective panel 50 fits into the upper part of the depth of the recess 22 leaving space for the inserts to be received within the remaining depth (e.g. 0.25 mm) of the recess. The panel 50 can be adhered to the rear face of the face panel 11.

In FIG. 16 there is a two part assembly of a base panel 20 (e.g. a laser cut plastics sheet) and a moulded face panel 11. The face panel 11 can be made of clear material so that the translucent layer comprises part of the face panel. In particular, with the face panel composed of a transparent material, the window 13 of the face panel is defined by opaque or less transparent areas 14 of the face panel where decorative or information matter is displayed and the translucent layer comprises the part of the face panel behind the window. Alternatively the face panel 11 may be of opaque material and the window is cut therethrough the UV curable glaze later applied filling and providing a clear protective layer in the window 13.

It will be seen that the preferred embodiment of the name badge illustrated in the drawings can be manufactured to provide an aesthetically attractive product which enables easy removal and replacement of information displayed in the window, e.g. a person's name. The name badge can be manufactured from economical materials without compromising the high quality appearance.

Although the invention has been illustrated with the one recess 22 provided in the base panel 20, the recess could instead be provided in the rear of the face panel 11 or partly in both face and base panels 11 and 20. A plurality of recesses, each accommodating an insert could also be provided in an alternative embodiment.

Multiple windows could be provided, for example, to allow for the name of an individual and the name of a department.

Inserts 40 could be made that extend across multiple bays 23, 24 but have complementary tabs 42, 43. This would allow for the printing of titles such as Mr, Mrs, Ms or Dr or other letter combinations such as Mc.

The bays 23, 24 may be provided with a profiled mouth to help guide in tabs 42, 43 to assist centre the insert 40 and guide the insert 40 into the bays 23, 24.

It is to be understood that various alterations, modifications and additions may be made to the features of the possible and preferred embodiments of the invention as herein described without departing from the scope of the invention as defined in the claims.

1. A portable display for visibly displaying personal information related to the bearer of the display, the portable display including:
a base panel having a front and a rear;
a face panel overlying the base panel and having at least one window through which indicia providing the personal information are visible;
at least one recess which is between the base panel and the face panel and which is shaped to receive and locate a plurality of removable inserts carrying said indicia;
the rear of the base panel having an access aperture in communication with said at least one recess through which said plurality of inserts can be selectively inserted and removed.

2. A portable display as claimed in claim 1 wherein said access aperture has a closed perimeter boundary entirely within the periphery of the rear of the base panel.

3. A portable display as claimed in claim 2 wherein the access aperture comprises an elongated slot in the rear of the base panel through which said inserts can be inserted and removed at different positions along the length of the elongated slot.

4. A portable display as claimed in claim 1 wherein the access aperture in the rear of the base panel in cross-section is offset from said at least one recess so that the inserts are required to bend upon being inserted and removed through the access aperture.

5. A portable display as claimed in claim 4 wherein each insert is made of a flexible and resilient material, the flexibility allowing deformation of the insert upon insertion through the access aperture into said at least one recess and upon removal of the insert from said at least one recess through the access aperture, the resilience enabling the insert to tend to return at least partially to its original shape upon being fully inserted through the access aperture into its desired final position in said at least one recess.

6. A portable display as claimed in claim 1 wherein each said at least one recess is a generally planar recess and wherein said access aperture provides no access to said at least one recess in the plane thereof whereby said inserts are required to bend upon being inserted through the access aperture into the planar recess and are required to bend upon being removed from the planar recess out through the access aperture.

7. A portable display as claimed in claim 1 and further including a translucent layer between the face panel and the base panel and which overlies the inserts when located in said at least one recess and which provides visibility for the indicia through said at least one window and said translucent layer.

8. A portable display as claimed in claim 7 wherein said translucent layer comprises a translucent protective panel interposed between the face panel and the base panel.

9. A portable display as claimed in claim 8 wherein the protective panel has a raised portion on the rear face of the protective panel, the raised portion being of complementary shape to said at least one recess but being of lesser thickness than the recess whereby both the raised portion of the protective panel and the inserts can be received within said at least one recess.

10. A portable display as claimed in claim 7 wherein the translucent layer comprises part of the face panel.

11. A portable display as claimed in claim 10 wherein the face panel is composed of a transparent material and the window of the face panel is defined by opaque or less transparent areas of the face panel where decorative or information matter is displayed.

12. A portable display as claimed in claim 8 wherein said protective panel comprises a transparent layer sandwiched between the base panel and the face panel.

13. A portable display as claimed in claim 1 wherein said at least one recess is defined by a formation on the front of the base panel shaped to receive and locate said plurality of removable inserts.

14. A portable display as claimed in claim 1 wherein said at least one recess is defined by a formation at a rear of the face panel.

15. A portable display as claimed in claim 1 wherein said at least one recess is defined by formations which are respectively provided in a front of the base panel and in the rear of the face panel, the respective formations together defining said at least one recess.

16. A portable display as claimed in claim 15 wherein the formation in the front of the base panel defines a series of recesses and wherein the facing formation in the rear of the face panel defines an alternating series of recesses so that the recesses visible through said window have their respective planes in alternating staggered configuration, each recess being shaped to accommodate therein a respective one of the removable inserts.

17. A portable display as claimed in claim 13 wherein each said at least one recess is shaped so that the insert is positively located and retained in its desired position therein to resist accidental displacement.

18. A portable display as claimed in claim 17 wherein each said at least one recess has a profiled part of its periphery to receive and locate a complementary shaped portion of the periphery of an insert to be received and located therein.

19. A portable display as claimed in claim 18 wherein said part of the periphery comprises a concave bay in the respective recess remote from the access aperture so as to receive and positively locate the respective insert at its periphery furtherest from the access aperture.

20. A portable display as claimed in claim 18 wherein said profiled part of the periphery comprises a concave bay adjacent to the access aperture so as to thereby receive and locate a shaped part of the insert proximate to the access aperture, the shaped part of the insert received within the concave bay proximate to the access aperture being accessible through the access aperture to enable removal of the insert back out through the access aperture.

21. A portable display as claimed in claim 20 wherein the access aperture is provided with a number of concave formations along an edge thereof aligned with and of similar shape to the concave bays in the recesses proximate to the access aperture, the concavities in the access aperture being operative to receive and assist location of respective inserts being inserted through the access aperture into the recesses and to enable access to the respective profiled parts of the peripheries of the inserts for removal of the inserts from the recesses through the access aperture.

22. A portable display as claimed in claim 13 wherein said at least one recess comprises a single elongated recess having a number of profiled sections in its periphery along its length, the profiled sections being located and operative to receive complementary shaped parts of the inserts whereby the inserts when located in position are all securely held against accidental movement during use of the portable display.

23. A portable display as claimed in claim 1 wherein each insert is made of transparent plastics material having the indicia applied thereto in a contrasting colour to a background visible through the window beyond the inserts.

24. A portable display as claimed in claim 1 wherein each insert is provided with a small hole which remains visible and accessible through the access aperture when the insert is located in its desired position, the small hole being engageable for drawing the insert back out through the access aperture.

25. In combination, a portable display and a plurality of removable inserts which carry indicia providing personal information related to the bearer of the display, the portable display including:
a base panel having a front and a rear;
a face panel overlying the base panel and having at least one window through which the indicia providing the personal information are visible;
at least one recess which is between the base panel and the face panel and which receives and locates therein the plurality of removable inserts carrying said indicia;
the rear of the base panel having an access aperture in communication with said at least one recess through which said plurality of inserts can be selectively inserted and removed, each insert being made of a flexible and resilient material, the flexibility allowing deformation of the insert upon insertion through the access aperture into said at least one recess and upon removal of the insert from said at least one recess through the access aperture, the resilience enabling the insert to tend to return at least partially to its original shape upon being fully inserted through the access aperture into its desired final position in said at least one recess.
